(19) United States
(12) Patent Application Publication
(10) Pub. No.: US 2008/0082342 A1
(43) Pub. Date: Apr. 3, 2008

(54) APPARATUS AND METHOD FOR PROVIDING CONTENT-INFORMATION SERVICE USING VOICE INTERACTION

(76) Inventors: Rock Won Kim, Daejeon (KR); Kang Woo Lee, Daejeon (KR); Young Ho Suh, Gwangju (KR); Min Young Kim, Chungju (KR); Yeon Jun Kim, Daejeon (KR); Hyun Kim, Daejeon (KR); Young Jo Cho, Sungnam (KR)

Correspondence Address: LADAS & PARRY LLP, 224 SOUTH MICHIGAN AVENUE, SUITE 1600, CHICAGO, IL, 60604, US

(21) Appl. No.: 11/856,821

(22) Filed: Sep. 18, 2007

(30) Foreign Application Priority Data
Sep. 28, 2006 (KR) 10-2006-0095049

(51) Int. Cl. G10L 11/00

(52) U.S. Cl. 704/275; 704/E15.001

(57) ABSTRACT

An apparatus for providing a content-information service comprises: a user-content interface for receiving content-provision request information collected by several user I/O interfaces which includes a voice recognition interface, and providing content data corresponding to the provision request information to users; a content-provision relay for requesting the content data using content-associated information corresponding to the content-provision request information, and transmitting the content data to the user-content interface; a content-information manager for registering and managing the content-associated information associated with the content data; and a content-storage unit for storing and managing a plurality of providable content data.

### CLAIM OF PRIORITY

This application claims the benefit of Korean Patent Application No. 2006-0095049 filed on Sep. 28, 2006 in the Korean Intellectual Property Office, the disclosure of which is incorporated herein by reference.

### BACKGROUND OF THE INVENTION

1. Field of the Invention

The present invention relates to an apparatus and method for providing a content-service over the Internet, and more particularly to an apparatus and method for providing a content-information service, which can search for content data corresponding to requested information over the Internet using a voice recognition interface, and can provide a user with the content data via a user interface.

This work was supported by the IT R&D program of MIC/IITA. [2006-S-026-01, Development of the URC Server Frame work for Proactive Robotic Services]

2. Description of the Related Art

Generally, users may access desired information using a personal computer or wired/wireless communication terminal capable of communicating with the Internet from among numerous information existing in the Internet. If the user-desired information retrieved from the Internet is displayed on a screen of a corresponding terminal, the user directly reads and determines the displayed information, and enters a new command in the displayed screen by clicking a mouse or key. The above-mentioned conventional method has been proposed to search for corresponding information using only the display of the corresponding terminal.

In addition to the above-mentioned conventional method, there has been developed a new method capable of acquiring corresponding information using voice data. According to the conventional method for searching for desired information using the voice data, the user can directly define a voice recognition list, and can perform an operation corresponding to each voice command.

For another example, “HTML” may be automatically converted into “Voice XML”. In this case, a control part contained in the HTML is extracted as the voice recognition list. In other words, this method extracts a hyperlink symbol contained in the HTTL, and uses the extracted hyperlink symbol as the voice recognition list. Similar to this example, there has recently been developed a yet another example in which GUI (Graphic User Interface) component information of a genera application is analyzed to extract control information, and then a voice recognition list corresponding to the control information is configured. In this case, the control information may also be used in the same manner as in the HTML's hyperlink.

If a user desires to receive a desired content-service from at least one content provider (CP), the user checks corresponding information displayed on the computer or communication terminal, and enters a specific-information display command, thereby checking his or her desired information.

In recent times, the digital home network environment is being rapidly extended to intelligent robots or household appliances. Several devices capable of interacting with the home network use a voice interface or an intelligent remote-controller to interact with the user. Provided that the user receives desired information via a voice interface provided by a robot and enters a command, a method for providing information using the voice interface may be inconvenient for the user, because the conventional voice interface method has been designed to update only the voice recognition list associated with the screen variation under an information-provision situation based on the screen. In other words, the conventional method has used the voice interface as an auxiliary device of the GUI, such that a variety of improvised correlations cannot be conducted between the user and the information provision service.

For example, provided that the user requests cooking information and a home-networking robot provides a service associated with the cooking information, the user may desire to query the robot for any question associated with the cooking material while the cooking order is audibly provided to the user. Therefore, the user may provide a command for commanding previous steps to be repeated, and may query the robot for unexpected question (e.g., a weather-associated question).

### SUMMARY OF THE INVENTION

Therefore, the present invention has been made in view of the above problems, and it is an object of the present invention to provide an apparatus and method for providing a content-information service via voice interaction.

It is another object of the present invention to provide an apparatus and method for providing a content-information service via voice interaction, which can recognize a corresponding-content provision request via several recognizable user I/O interfaces which includes a voice recognition function, and can transmit corresponding content data to the users by interacting with the users.

In accordance with one aspect of the present invention, the above and other objects can be accomplished by the provision of an apparatus for providing a content-information service comprising: a user-content interface for receiving provision request information of corresponding content data collected by several user input/output (I/O) interfaces which comprises a voice recognition function, and transmitting the content data corresponding to the provision request information to users via the user I/O interfaces; a content-provision relay for requesting content-associated information corresponding to the content-provision request information received in the user-content interface, requesting content data corresponding to the content-associated information, and transmitting corresponding content data to the user-content interface; a content-information manager for registering and managing the content-associated information associated with the content data capable of being provided to the user-content interface, and providing content-associated information upon receiving the content-associated information request from the content-provision relay; and a content-storage unit for storing and managing a plurality of providable content data according to the content-associated information, detecting content data corresponding to the content-associated information requested by the content-provision relay, and providing the detected content data.

The user-content interface comprises: a content-provision request command generator for generating a command corresponding to the provision request information of the corresponding content data to providing the command to the content-provision relay; and a content-output unit for providing the content data received from the content-provision relay unit to the user upon receiving the command from the content-provision request command generator.

The content-provision request command generator collects the provision request information of the content data using at least one of a voice recorder, a GUI (Graphic User Interface) unit, and a sensor drive.

The voice recorder audibly records the provision request information of the content data, and generates the content-provision request command.

The GUI unit and the sensor drive map the content-provision request information to a voice command symbol on the basis of a predetermined control map table.

The content-output unit comprises at least one of an audio output init, a GUI display, and an actuator, wherein the audio output unit audibly outputs the content data received from the content-provision relay, the GUI display displays the content data configured in the form of GUI data on a screen, and the actuator drives a predetermined hardware unit corresponding to the content data.

The GUI data has one format of an image file and a Hyper Text Markup Language (HTML) document.

The content-information manager comprises: a content-registration information manager for registering and managing content-associated information of content data capable of being received via the content-storage unit; and a content-information provider for receiving a content-associated information request from the content-provision relay, detecting content-associated information corresponding to the requested content data from the content-registration information manager, and providing the detected content-associated information to the content-provision relay.

The apparatus further comprises: a voice manager for determining whether the content-provision request information transmitted from the user-content interface to the content-provision relay is valid information, converting text data of the content data transmitted from the content-storage unit to the content-provision relay into audio data, and transmitting the determined and converted result information to the content-provision relay.

In accordance with another aspect of the present invention, there is provided a method for providing a content-information service comprising: receiving provision request information of corresponding content data via several user input/output (I/O) interfaces; requesting content-associated information corresponding to the content-provision request information, requesting content data corresponding to the content-associated information; providing content-associated information corresponding to the content-associated information request; requesting content data corresponding to the provided content-associated information; detecting content data corresponding to the requested content-associated information; and outputting the detected content data for a user.

The receiving content-provision request information comprises: collecting the content-provision request information using at least one of a voice recorder, a GUI (Graphic User Interface) unit, and a sensor.

The requesting content-associated information comprises: audibly recording the provision request information of the content data, and generating the content-provision request command.

The requesting content-associated information comprises: mapping the content-provision request information collected by the GUI or sensor to a voice command symbol on the basis of a predetermined control map table.

The outputting the detected content data comprises: audibly converting the received content data into audio data; displaying the content data in the form of GUI data on a screen, or driving a predetermined hardware unit corresponding to the content data, whereby the content data are outputted.

The method further comprises: after the requesting content-associated information, determining whether the content-provision request information is valid information, whereby the requesting content-associated information comprises requesting the content-associated information associated with the valid information.

The method further comprises: after the detecting content data, converting text data of the detected content data into audio data, and the outputting the content data comprises outputting the content data configured in the form of the converted audio data to the user.

The present invention provides an apparatus and method for providing a content-information service via voice interaction. The present invention recognizes corresponding-content provision request information configured in the form of voice- or text-data entered by a user via either a voice recognition interface and/or a user I/O interface, searches for content data corresponding to the user-requested information, and provides the user with the retrieved content data via the user I/O interface, such that a variety of communication devices installed into a digital home network or vehicle can provide the user with the corresponding content-information service via the user I/O interface, irrespective of the presence or absence of a display.

### BRIEF DESCRIPTION OF DRAWINGS

The above and other objects, features and other advantages of the present invention will be more clearly understood from the following detailed description taken in conjunction with the accompanying drawings, in which:

FIG. 1 is a block diagram illustrating an apparatus for providing a content-service via a voice recognition function according to a preferred embodiment of the present invention;

FIG. 2 is a schema structure of a Content Item Table (CIT) according to a preferred embodiment of the present invention;

FIG. 3 is a schema structure of a Content Item Control Table (CICT) according to a preferred embodiment of the present invention;

FIG. 4 is a schema structure of a Content Data Table (CDT) according to a preferred embodiment of the present invention;

FIG. 5 is an exemplary data structure of Content Info Request (CIR) information according to a preferred embodiment of the present invention;

FIG. 6 is an exemplary data structure of Content Information according to a preferred embodiment of the present invention;

FIG. 7 is a schema structure of Content Session Table (CST) according to a preferred embodiment of the present invention;

FIG. 8 is a schema structure of Voice Record (VR) information according to a preferred embodiment of the present invention;

FIG. 9 is a schema structure of Control Command (CC) information according to a preferred embodiment of the present invention; and

FIG. 10 is a schema structure of a Control Map (CM) according to a preferred embodiment of the present invention.

### DETAILED DESCRIPTION OF THE PREFERRED EMBODIMENT

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

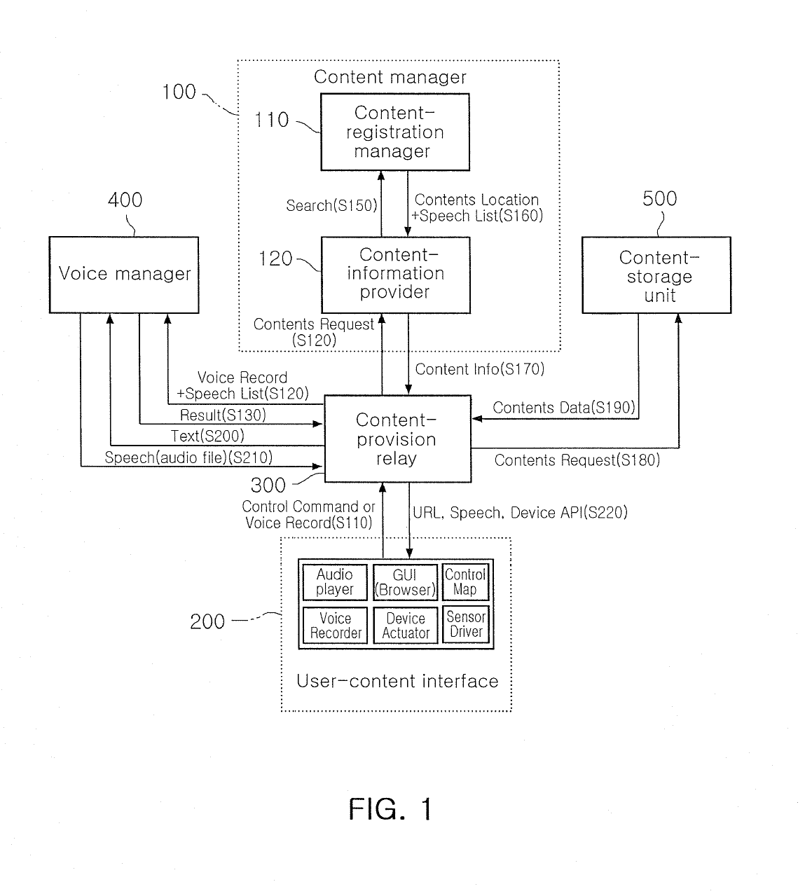

FIG. 1 is a block diagram illustrating an apparatus for providing a content-service via a voice interaction according to a preferred embodiment of the present invention.

Referring to FIG. 1, the apparatus for providing a content service via a voice interaction according to the present invention comprises a content manager 100, a user-content interface 200, a content-provision relay 300, a voice manager 400, and a content-storage unit 500.

The content manager 100 manages and provides providable content information. For this purpose, the content manager 100 comprises a content-registration manager 110 and a content-information provider 120.

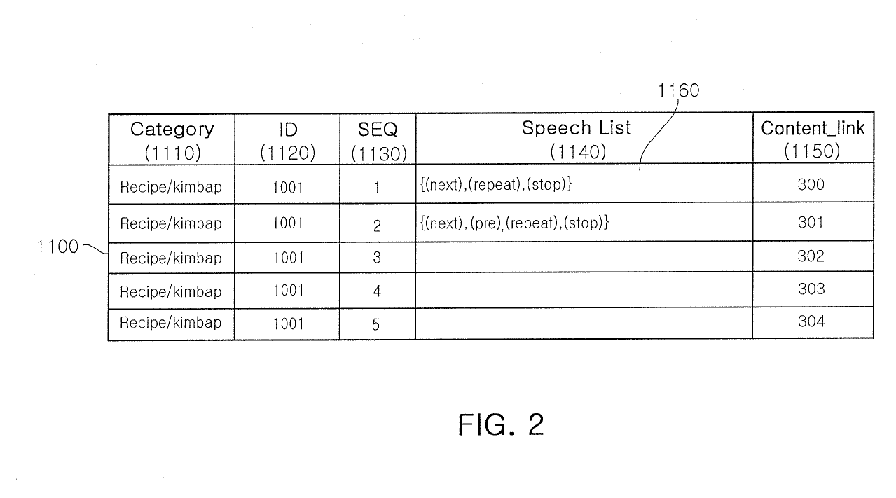

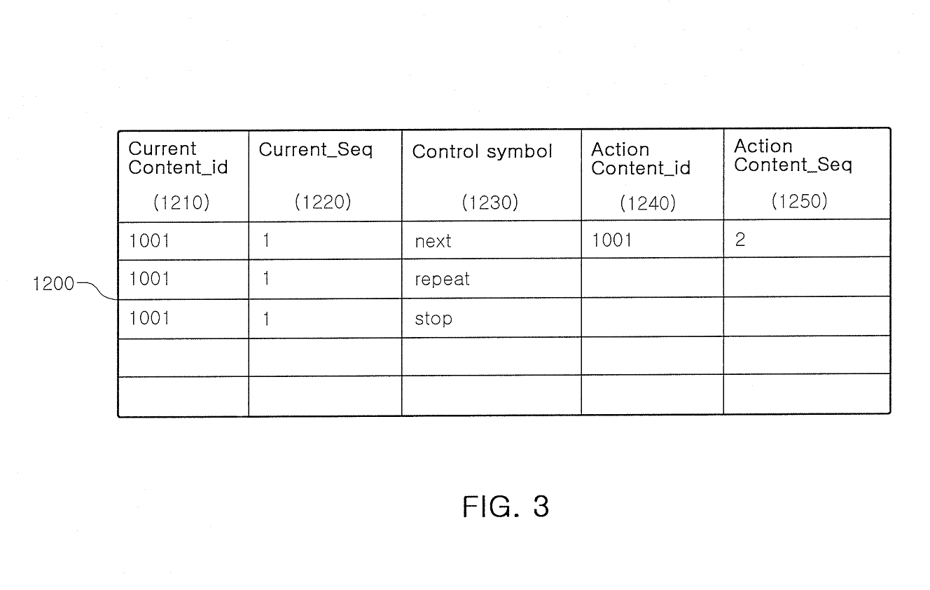

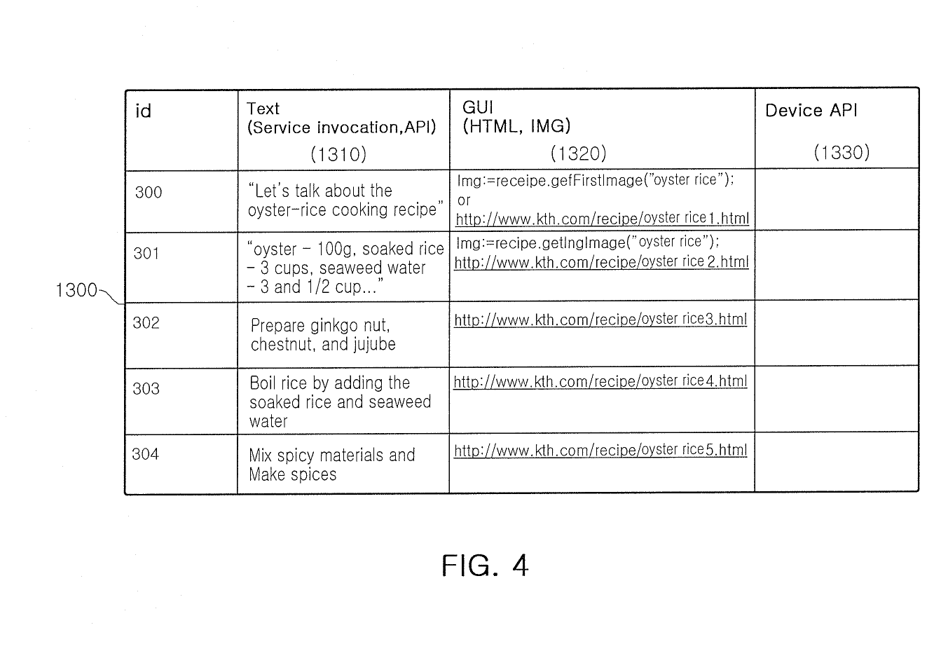

The content-registration manager 110 stores and manages control information required for accessing content data and content-address information. For this purpose, the content-registration manager 110 stores and manages the content item table (See FIG. 2), the content item control table (See FIG. 3), and the content data table (See FIG. 4), and provides a search interface for each of the content item table, the content item control table, and the content data table. In other words, upon receiving a content search command, the content-registration manager 110 searches for content-control information (i.e., Contents Location+Speech List) corresponding to the content search command, and transmits the retrieved content-control information to the content-information provider 120.

Upon receiving a content-info request from the content-provision relay 300, the content-information provider 120 searches for the content control information (i.e., Contents Location+Speech List) corresponding to the content request information in the content-registration manager 110. The content-information provider 120 generates content information corresponding to the retrieved content control information (i.e., Contents Location+Speech List), and transmits the content information to the content-provision relay 300.

The user-content interface 200 receives a content-provision request command (i.e., Control Command or Voice Record) from the user, and transmits the received content-provision request command to the content-provision relay 300. The user-content interface 200 receives content data (i.e., URL, Speech, and Device API) corresponding to the requested command from the content-provision relay 300, and transmits the received content data to the content-requesting user via the user interface.

The user-content interface 200 may be embodied in all the devices (e.g., mobile phones, WIBRO-terminals, robots, and digital home devices) capable of being connected to the network. The user-content interface 200 may be provided to the user via an audio, an API (Application Program Interface), and a GUI if the user has a display. The user-content interface 200 records a user's voice so as to transmit the user-entry command to the content-provision relay 300. This is called a voice record function.

The user-content interface 200 generates a control command using the GUI or any device according to a user command.

The content-provision relay 300 receives a control command or voice record information from the user-content interface 200. Upon receiving the control command, the content-provision relay 300 transmits the content info request to the content-information provider 120. Upon receiving the voice record information, the content-provision relay 300 transmits the voice record information and a valid voice command list (i.e., Voice Record+Speech List) stored in a client session table to the voice manager 400, and receives the resultant information from the voice manager 400. In this case, the voice manager 400 recognizes the received voice record information and the valid voice command list as recognizable information according to the automatic speech recognition (ASR) method.

If the voice recognition result is determined to be valid information, the content-provision relay 300 generates the content info request, and transmits the content info request to the content-information provider 120. Otherwise, if the voice recognition result is not equal to the valid information, the content-provision relay 300 ignores the voice recognition result or transmits an error event to the user-content interface 200.

The content-provision relay 300 receives content information from the content-information provider 120 as a response to the content info request. Therefore, the content-provision relay 300 requests the content provision from the content-storage unit 500, and receives the content data stored in the content-storage unit 500.

In this case, if the retrieved content data is text data, the content-provision relay 300 converts the received content data into a speech file acting as an audio file using a TTS (Text to Speech) function of the voice manager 400, and transmits the converted result along with the GUI- and Device API-information to the user-content interface 200. Therefore, the user-content interface 200 outputs the content data (i.e., URL, Speech, and Device API) received from the content-provision relay to the user via the user interface.

FIG. 1 sequentially shows a flow for requesting and providing content data. The above-mentioned steps (S110˜S220) have disclosed technical characteristics of individual blocks, such that a detailed description thereof will herein be omitted for the convenience of description.

FIG. 2 is a schema structure of a Content Item Table (CIT) according to a preferred embodiment of the present invention.

Referring to FIG. 2, the content item table 1100 includes information of constituent units of the content data. The constituent unit information includes a category 1110 for representing a concept of the content data, an ID 1120 of a content item, a SEQ 1130 for identifying constituent components contained in the same content-item ID, a speech list (i.e., a voice command recognition list) 1140 capable of being received from the user when a current content item is transmitted to the client, and a content link 1150 for referring to one of records of the content data table storing actual content data.

In this case, the control symbol list 1160 is stored in the speech list 1140. A specific item having the same content item ID 1120 from among several content items stored in the content item table 1100 belongs to the same content data.

FIG. 3 is a schema structure of a Content Item Control Table (CICT) according to a preferred embodiment of the present invention.

Referring to FIG. 3, the content item control table 1200 includes a plurality of control action information expressed in the control symbol list 1160 defined in the speech list 1140 indicative of attributes of the content item table 1100.

The content item control table 1200 includes a current content ID 1210, current content data (Current Seq) 1220, a control symbol 1230, an action content ID 1240, and current action content information (Action Content Seq) 1250.

The current content ID 1210 and the current Seq 1220 are used as keys for referring to records of the content item table 1100.

The control symbol 1230 indicates a symbol of a specific command capable of being selected by the user. This symbol must be pre-defined in the control symbol list 1160 of the speech list 1140 acting as a food command of the content item table 1100.

The action content ID 1240 and the Action Content Seq 1250 are indicative of content data reacting to the control symbol 1230 entered by the client. The action content ID 1240 refers to the content item ID 1120, and the Action Content Seq 1250 refers to the SEQ 1130.

FIG. 4 is a schema structure of a Content Data Table (CDT) according to a preferred embodiment of the present invention.

Referring to FIG. 4, the content data table 1300 indicates a content access path via which content data can be retrieved from a physical server including actual content data.

Therefore, the content data may be composed of a text attribute 1310, a GUI attribute 1230, and a Device API attribute 1330.

The text attribute 1310 indicates a record stored in the content item table 1100. The text attribute 1310 is converted into a voice file by the content-provision relay 300 via the voice manager 400, such that the voice file is transmitted to the user via the user-content interface 200. In this case, the text attribute 1310 may also store an address value (i.e., URL) capable of acquiring a text value.

The GUI attribute 1320 indicates a link of image information denoted on a display of the user-content interface 200.

If the client device for receiving the content data includes a speaker and a display and can conduct a specific operation or gesture like a robot, the Device API attribute 1330 designates a client behavior executed when content data is executed.

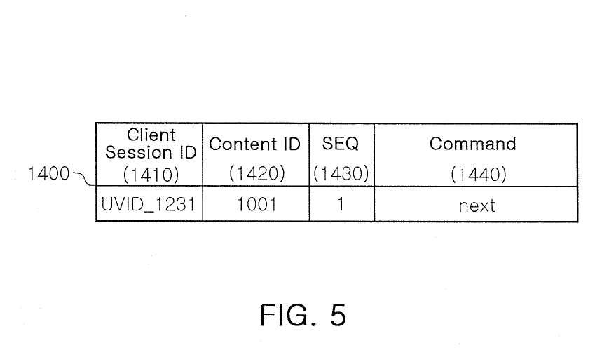

FIG. 5 is an exemplary data structure of Content Info Request (CIR) information for requesting the content-associated information corresponding to the content-provision request information in a preferred embodiment of the present invention.

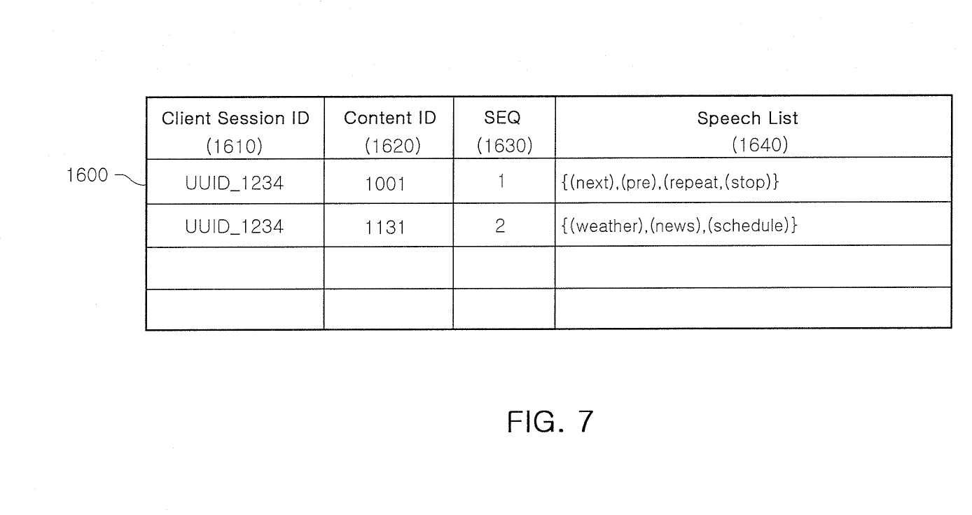

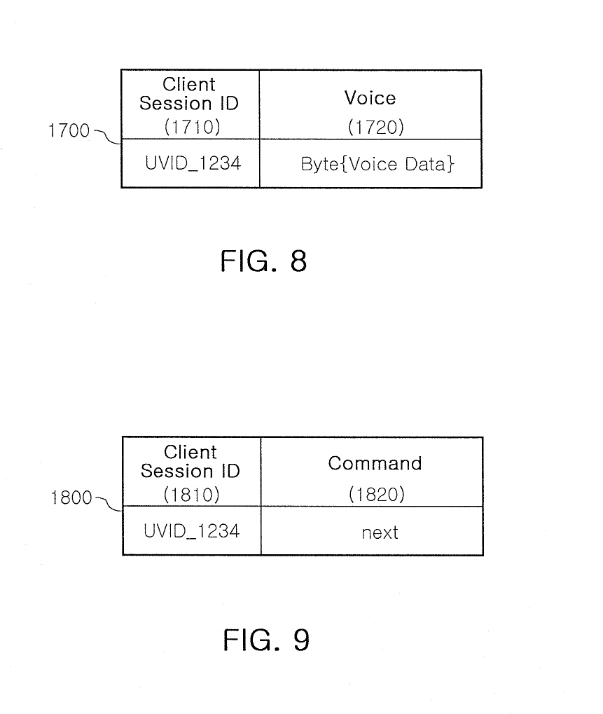

Referring to FIG. 5, the Content Info Request information 1400 is generated by the content-provision relay 300 of FIG. 1. The content-provision relay 300 receives the Voice Record information (See 1700 of FIG. 8) from the user-content interface 200. In this case, the content-provision relay 300 transmits a variety of attribute values to the voice manager 400, for example, a voice attribute value (Voice) (See 1720 of FIG. 8) of the Voice Record information 1700, a Client Session ID (See 1710 of FIG. 8), a Client Session Table (See 1600 of FIG. 7) corresponding to the Client Session ID 1710, and a Speech List (See 1640 of FIG. 7) attribute value.

The content-provision relay 300 receives validity resultant information of the transmission information from the voice manager 400. If the recorded voice is determined to be a valid command, the content-provision relay 300 generates the Content Info Request 1400 using the Client Session Table 1600 and the valid command, and transmits the Content Info Request 400 to the content-information provider 120.

In the meantime, upon receiving a control command (See 1800 of FIG. 9) from the user-content interface 200, the content-provision relay 300 generates the Content Info Request information 1400 using the Command attribute value 1820 of the Control Command 1800 and the voice record information having the Client Session ID value 1610 contained in the Client Session Table 1600, and transmits the Content Info Request 1400 to the content-info relay 120.

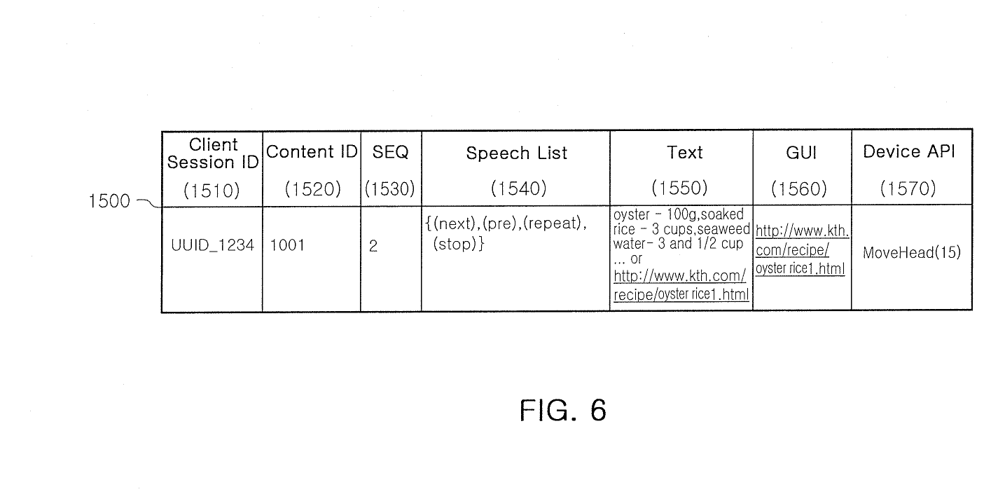

FIG. 6 is an exemplary data structure of Content-associated Information (Content Info) according to a preferred embodiment of the present invention.

Referring to FIG. 6, the Content Info 1500 includes a Client Session ID 1510 for identifying category information of the user-content interface 200 capable of transmitting content information, a Content ID 1520 for identifying user-desired content data and its constituent element SEQ 1530, a Speech List 1540 indicative of a list of valid commands acquired when the current content element is executed, Text 1550 for extracting a detailed value from the attribute value stored in the Content Data Table 1300, GUI information 1560, and a Device API 1570.

A method for generating the Content Info 1500 according to the present invention will hereinafter be described. The content-information provider 120 searches for voice record information including the same attribute values as three values (i.e., a Content ID 1420, a SEQ 1430, and a Command 1440 contained in the Content Info Request 1400) in the Content Item Control Table 1200.

Thereafter, the content-information provider 120 searches for voice record information of the content item table 1100, which includes the ID 1120 having the same value as that of the Action Content ID 1240 and the Action Content Seq 1250 having the same value as that of the SEQ 1130, and searches for voice record information of the content data table 1300 referring to attributes of the content link 1150 of the searched voice record information.

Therefore, the content-information provider 120 enters the voice record ID attribute 1120 of the Content Item Table 1100 in the Content ID 1520 of the Content Info 1500, enters the SEQ attribute 1120 of the Content Item Table 1100 in the SEQ 1530 of the Content Info 1500, and enters the Speech List attribute 1140 in the Speech List 1540 of the Content Info 1500. The content-information provider 120 enters the voice record Text 1310 of the Content Data Table 1300 in the Text 1550 of the Content Info 1500, enters the GUI 1320 of the Content Data Table 1300 in the GUI 1560 of the Content Info 1500, and enters the Device API 1330 of the Content Data Table 1300 in the Device API of the Content Info 1500.

FIG. 7 is a schema structure of Content Session Table (CST) according to a preferred embodiment of the present invention.

Referring to FIG. 7, the Content Session Table 1600 performs a variety of calculations (e.g., generation, update, and deletion) by the content-provision relay 300. The attribute information of the Content Session Table 1600 includes a Client Session ID 1610, a Content ID 1620, a SEQ 1630, and a Speech List 1640. The Client Session ID 1610 acts as an ID for identifying a session currently executed in the user-content interface 200. The Content ID 1620 indicates content used by an execution session. The SEQ 1630 indicates a constituent element of content data. The Speech List 1640 stores the list of valid commands within the current content data or constituent element.

A Client Session ID 1610 is continuously updated during the session, and is deleted if the session is terminated. In the case of values for generating and updating any voice record information of the Client Session Table 1600, values of the Content ID 1520, the SEQ 1530, and the Speech List 154 contained in the Content Info 1500 received from the content-information provider 120 and the value of the Client Session ID 1710 or 1810 contained in either the Voice Record 1700 or the Control Command received from the user-content interface 200 are extracted, such that the extracted values are stored in the corresponding attribute.

FIG. 8 is a schema structure of Voice Record (VR) information according to a preferred embodiment of the present invention.

Referring to FIG. 8, if a user's voice is recorded by the voice recorder contained in the user-content provider 200 when the user enters the Voice Command, the Voice Record 1700 is filled with Voice Record attribute values 1720, and the resultant Voice Record along with the Client Session ID 1710 is transmitted to the content-provision relay 300.

FIG. 9 is a schema structure of Control Command (CC) information according to a preferred embodiment of the present invention.

Referring to FIG. 9, if an event is received from the GUI or Sensor Driver of the user-content interface 200, the Control Command 1800 allows a command symbol associated with a current state and input event to be filled with the attribute values of the Command 1820 by referring to the control map, and transmits the resultant information along with the Client Session ID 1810 to the content-provision relay 300.

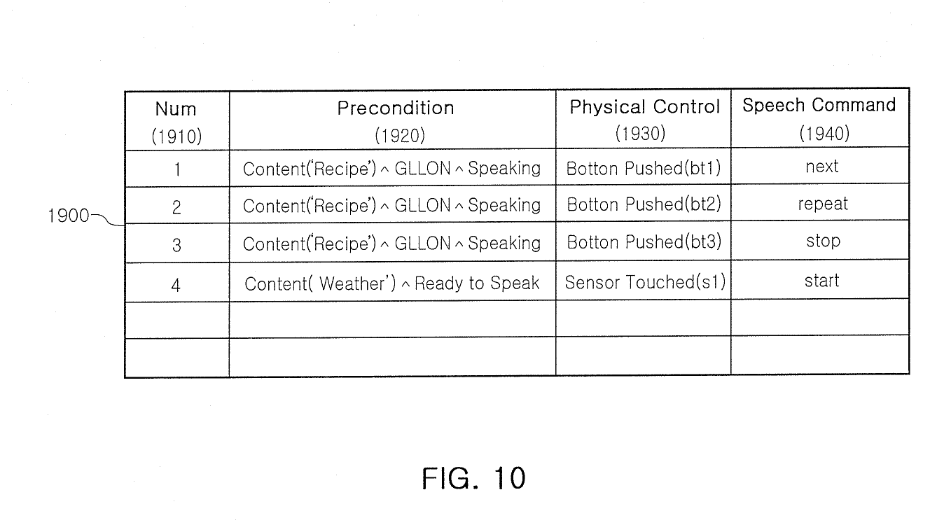

FIG. 10 a schema structure of a Control Map (CM) according to a preferred embodiment of the present invention.

Referring to FIG. 10, the control map 1900 includes the Pre Condition 1920, the Physical Control 1930, and the Speech Command 1940. The Pre Condition 1920 logically represents a status condition of the user-content interface 200. The Physical Control 1930 indicates a control event received from the GUI or Sensor Driver. If the Pre Condition 1920 and the Physical Control 1930 are satisfied, the Speech Command 1940 stores a user-intended command symbol.

The above-mentioned voice record values must be pre-established before the user-content interface 200 is executed in consideration of hardware characteristics and content-information service categories of the user-content interface 200. If the Content or the GUI is updated, the Control Map 1900 must be updated.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

As apparent from the above description, an apparatus and method for providing a content-information service via voice interaction according to the present invention recognizes corresponding-content provision request information configured in the form of voice- or text- data entered by a user via either a voice recognition interface and/or a user I/O interface, searches for content data corresponding to the user-requested information, and provides the user with the retrieved content data via the user I/O interface, such that a variety of communication devices installed into a digital home network or vehicle can provide the user with the corresponding content-information service via the user I/O interface, irrespective of the presence or absence of a display.

What is claimed is:

1. An apparatus for providing a content-information service comprising:
a user-content interface for receiving content-provision request information collected by several user input/output (I/O) interfaces which includes a voice recognition function, and transmitting content data corresponding to the content-provision request information to users via the user I/O interfaces;
a content-provision relay for requesting content-associated information corresponding to the content-provision request information received in the user-content interface, requesting content data corresponding to the content-associated information, and transmitting corresponding content data to the user-content interface;
a content-information manager for registering and managing the content-associated information associated with the content data capable of being provided to the user-content interface, and providing content-associated information upon receiving the content-associated information request from the content-provision relay; and
a content-storage unit for storing and managing a plurality of providable contents data, detecting content data corresponding to the content-associated information requested by the content-provision relay, and providing the detected content data.

2. The apparatus according to claim 1, wherein the user-content interface comprises:
a content-provision request command generator for generating a command corresponding to the content-provision request information, and providing the command to the content-provision relay; and
a content-output unit for receiving the content data corresponding to the command of the content-provision request command generator from the content-provision relay to providing the content data to the user I/O interface.

3. The apparatus according to claim 2, wherein the content-provision request command generator collects the provision request information of a content data using at least one of a voice recorder, a GUI (Graphic User Interface) unit, and a sensor drive.

4. The apparatus according to claim 3, wherein the voice recorder audibly records the provision request information of a content data, and generates the content-provision request command.

5. The apparatus according to claim 3, wherein the GUI unit and the sensor drive map the content-provision request information to a voice command symbol on the basis of a predetermined control map table.

6. The apparatus according to claim 2, wherein the content-output unit comprises at least one of an audio output init, a GUI display, and an actuator, wherein
the audio output unit audibly outputs the content data received from the content-provision relay,
the GUI display displays the content data configured in the form of GUI data on a screen, and
the actuator drives a predetermined hardware unit corresponding to the content data.

7. The apparatus according to claim 6, wherein the GUI data has one of an image file and a Hyper Text Markup Language (HTML) document.

8. The apparatus according to claim 1, wherein the content-information manager comprises:
a content-registration information manager for registering and managing content-associated information of content data stored in the content-storage unit; and
a content-information provider for receiving content-associated information request from the content-provision relay, detecting content-associated information corresponding to the requested content data from the content-registration information manager, and providing the detected content-associated information to the content-provision relay.

9. The apparatus according to claim 1, further comprising:
a voice manager for determining whether the content-provision request information transmitted from the user-content interface to the content-provision relay is valid information, converting text data of the content data transmitted from the content-storage unit to the content-provision relay into audio data, and transmitting the determined and converted result information to the content-provision relay.

10. A method for providing a content-information service comprising:
receiving content-provision request information via several user input/output (I/O) interfaces;
requesting content-associated information corresponding to the content-provision request information;
providing the content-associated information corresponding to the content-associated information request;
requesting content data corresponding to the provided content-associated information;
detecting content data corresponding to the requested content-associated information; and
outputting the detected content data for a user.

11. The method according to claim 10, wherein the receiving content-provision request information comprises:
collecting the content-provision request information using at least one of a voice recorder, a GUI (Graphic User Interface) unit, and a sensor.

12. The method according to claim 11, wherein the requesting content-provision request information comprises:
audibly recording the content-provision request information, and generating the content-provision request command.

13. The method according to claim 11, wherein the requesting content-associated information comprises:
mapping the content-provision request information collected by the GUI or sensor to a voice command symbol on the basis of a predetermined control map table.

14. The method according to claim 10, wherein the outputting the detected content data comprises:
audibly outputting the received content data;
displaying the content data in the form of GUI data on a screen, or
driving a predetermined hardware unit corresponding to the content data,
whereby the content data are outputted.

15. The method according to claim 10, further comprising:
after the receiving content-provision request information, determining whether the content-provision request information is valid information,
whereby the requesting the content-associated information comprises requesting the content-associated information associated with the valid information.

16. The method according to claim 10, further comprising:
after the detecting content data, converting text data of the detected content data into audio data, and
the outputting the content data comprises outputting the content data configured in the form of the converted audio data to the user.
